(19) United States
(12) Patent Application Publication
(10) Pub. No.: US 2016/0103924 A1
(43) Pub. Date: Apr. 14, 2016

(54) METHOD AND APPARATUS FOR ACQUIRING INFORMATION DIGEST

(71) Applicant: TENCENT TECHNOLOGY (SHENZHEN) COMPANY LIMITED, Shenzhen (CN)

(72) Inventors: Zhihao ZHENG, Shenzhen (CN); Yan ZHAO, Shenzhen (CN); Jianjun YANG, Shenzhen (CN); Yiguo YANG, Shenzhen (CN); Lu HAN, Shenzhen (CN); Qiyun SU, Shenzhen (CN)

(21) Appl. No.: 14/974,164

(22) Filed: Dec. 18, 2015

Related U.S. Application Data
(63) Continuation of application No. PCT/CN2015/072895, filed on Feb. 12, 2015.

(30) Foreign Application Priority Data
Feb. 12, 2014 (CN) 201410048375.5

(51) Int. Cl. G06F 17/30; H04L 29/08

(52) U.S. Cl. CPC G06F 17/30876; H04L 67/22; G06F 17/30598

(57) ABSTRACT

A method and an apparatus for acquiring an information digest, which belong to the field of the Internet. The method includes: acquiring, according to user information of a user and attribute information of each piece of network information, a click-through rate of clicking a keyword corresponding to each piece of network information by the user (110); combining a preset number of keywords having highest click-through rates to form a first keyword set, and sending the first keyword set to a terminal corresponding to the user (102); receiving a second keyword set sent by the terminal, the second keyword set including a keyword selected by the user from the first keyword set (103); and acquiring an information digest of network information corresponding to each keyword in the second keyword set, and sending the information digest to the terminal (104).

### CROSS REFERENCE TO RELATED APPLICATIONS

This is a continuation application of International Patent Application No. PCT/CN2015/072895, filed on Feb. 12, 2015, which claims priority to Chinese Patent Application No. 201410048375.5 filed on Feb. 12, 2014, the disclosures of which are incorporated by reference herein in their entirety.

### FIELD OF THE TECHNOLOGY

The present disclosure relates to the field of the Internet, and in particular, to a method and an apparatus for acquiring an information digest.

### BACKGROUND OF THE DISCLOSURE

Currently, as more and more commodity information floods the Internet, how to help a user browse a massive amount of commodity information is an urgent problem needing to be solved. At present, in order to solve the problem, information digests of commodity information may be acquired first, and are displayed to the user; after browsing the information digests, the user determines commodity information that the user needs browse for details, and then the commodity information determined by the user is displayed for the user.

A current method for acquiring an information digest of commodity information may be as follows: when a user chats by using an instant messaging tool, a server acquires user information of the user, where the user information includes the age, the gender, interests and hobbies, and a geographical location of the user, and/or a behavior record of the user in a latest period of time; the server predicts, according to the user information and attribute information of each piece of stored commodity information, a click-through rate of clicking each piece of commodity information by the user, where the attribute information of the commodity information includes a user gender, a user age range, a geographical range, and a time range to which the commodity information is applicable, and/or at least one keyword corresponding to the commodity information; the server selects a piece of commodity information having a highest click-through rate, where a higher click-through rate of clicking the commodity information by the user indicates that the user is more interested in the commodity information; and the server sends an information digest corresponding to the commodity information and an identifier of the commodity information to a terminal corresponding to the user, where the information digest includes information such as the identifier of the commodity information, and a picture and a content subject that correspond to the commodity information.

The terminal displays the information digest of the commodity picture in a preset area of a chat interface. When the user needs to acquire the commodity information, the user may click the information digest. Then, the terminal acquires the commodity information from the server according to the identifier of the commodity information included in the information digest, and displays the commodity information to the user.

In the implementation of the present disclosure, the inventor finds that the existing technology at least has the following problems:

the chat interface of the instant messaging tool can only display the information digest of one piece of commodity information, which is limited in quantity, therefore failing to provide more choices for the user and failing to meet user's requirement for a large amount of commodity information.

### SUMMARY

In order to provide more choices for a user and meet user's requirement for a large amount of commodity information, the present disclosure provides a method and an apparatus for acquiring an information digest. Technical solutions are as follows:

A method for acquiring an information digest includes:

acquiring, according to user information of a user and attribute information of each piece of network information, a click-through rate of clicking a keyword corresponding to each piece of network information by the user;

acquiring, according to user information of a user and attribute information of each piece of network information, a click-through rate of clicking a keyword corresponding to each piece of network information by the user;

acquiring, according to user information of a user and attribute information of each piece of network information, a click-through rate of clicking a keyword corresponding to each piece of network information by the user;

receiving a second keyword set sent by the terminal, the second keyword set including a keyword selected by the user from the first keyword set; and

receiving a second keyword set sent by the terminal, the second keyword set including a keyword selected by the user from the first keyword set; and

An apparatus for acquiring an information digest includes:

a first acquisition module, configured to acquire, according to user information of a user and attribute information of each piece of network information, a click-through rate of clicking a keyword corresponding to each piece of network information by the user;

a sending module, configured to combine a preset number of keywords having highest click-through rates to form a first keyword set, and send the first keyword set to a terminal corresponding to the user;

a receiving module, configured to receive a second keyword set sent by the terminal, the second keyword set including a keyword selected by the user from the first keyword set; and

a second acquisition module, configured to acquire an information digest of network information corresponding to each keyword in the second keyword set, and send the information digest to the terminal.

In the embodiments of the present invention, a server sends a first keyword set consisting of several keywords having highest click-through rates to a terminal corresponding to a user, so that the user may select, in the first keyword set, a keyword in which the user is interested, so as to acquire an information digest page including multiple pieces of network information related to the selected keyword, and select, according to network information digests, network information that the user wants to acquire; the embodiments of the present invention provide more choices for the user, and meet user's requirement for a large amount of network information.

### BRIEF DESCRIPTION OF THE DRAWINGS

FIG. 1 is a flowchart of a method for acquiring an information digest according to Embodiment 1 of the present invention;

FIG. 2-1 is a flowchart of a method for acquiring an information digest according to Embodiment 2 of the present invention;

FIG. 2-2 is a schematic diagram of displaying keywords in a preset area of an instant messaging chat interface according to Embodiment 2 of the present invention;

FIG. 2-3 is a schematic diagram of a blank page added with information digests according to Embodiment 2 of the present invention; and

FIG. 3 is a schematic structural diagram of an apparatus for acquiring an information digest according to Embodiment 3 of the present invention.

### DESCRIPTION OF EMBODIMENTS

In order to make the objectives, technical solutions, and advantages of the present disclosure more comprehensible, the implementation manners of the present disclosure are described in further detail below with reference to the accompanying drawings.

In the embodiments of the present invention, a network information provider releases network information to a server. When releasing the network information, the provider may set a weight of the network information, and a user gender, a user age range, an area, and a time range to which the network information is applicable; the weight may be a price, namely, a price that the provider needs to pay each time the network information is clicked by a user.

Each piece of network information at least includes information content and a content subject; the server may extract a keyword from the information content and the content subject of the network information, where the extracted keyword is used for describing the content subject included in the network information. Then, the server uses information, such as the keyword corresponding to the network information, and the user gender, user age range, area, and time range which are set by the provider and to which the network information is applicable, as attribute information of the network information.

In addition, the server categorizes each piece of the released network information according to a keyword, categorizes identifiers of network information corresponding to a same keyword into one network information set, and stores the keyword and the network information set in a correspondence between keywords and network information sets.

For example, a network information provider releases network information “BB brandwoolen sweater” to a server, where the network information is information in a purchase page of “BB brandwoolen sweater”. When releasing the network information, the provider may select 18 years old to 30 years old as the user age range to which the network information is applicable, female as the user gender to which the network information is applicable, Beijing as the area to which the network information is applicable, and 12:00 to 24:00 every day as the time range to which the network information is applicable, and add a link of the purchase page of the network information. The server may acquire the attribute information of the network information and the link, and capture information in the purchasing page of “BB brandwoolen sweater” by using the acquired link.

The server may acquire information content and a content subject that are included in the information captured in the purchase page of “BB brand woolen sweater”, and extract keywords “BB brand” and “woolen sweater” from the acquired information content and content subject.

If the correspondence between keywords and network information sets includes a record of the keyword “BB brand” and a corresponding network information set, an identifier of the information captured in the purchase page of “BB brand woolen sweater” is stored in the network information set included in the record. If the correspondence between keywords and network information sets does not include the record of the keyword “BB brand” and the corresponding network information set, a correspondence between the keyword “BB brand” and the corresponding network information set is created, and the identifier of the information captured in the purchase page of “BB brand woolen sweater” is stored in the network information set of the correspondence. If the correspondence between keywords and network information sets includes a record of the keyword “woolen sweater” and a corresponding network information set, an identifier of the information captured in the purchase page of “BB brand woolen sweater” is stored in the network information set included in the record. If the correspondence between keywords and network information sets does not include the record of the keyword “woolen sweater” and the corresponding network information set, a correspondence between the keyword “woolen sweater” and the corresponding network information set is created, and the identifier of the information captured in the purchase page of “BB brand woolen sweater” is stored in the network information set of the correspondence.

### Embodiment 1

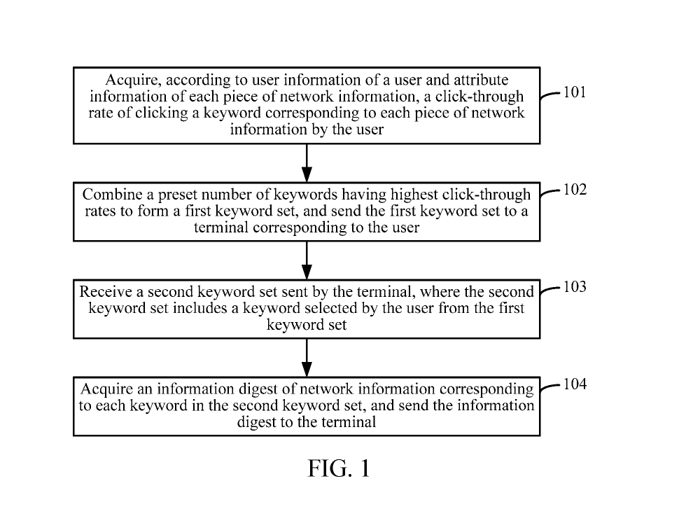

Referring to FIG. 1, this embodiment of the present invention provides a method for acquiring an information digest, including:

Step 101: Acquire, according to user information of a user and attribute information of each piece of network information, a click-through rate of clicking a keyword corresponding to each piece of network information by the user.

Step 102: Combine a preset number of keywords having highest click-through rates to form a first keyword set, and send the first keyword set to a terminal corresponding to the user.

Step 103: Receive a second keyword set sent by the terminal, where the second keyword set includes a keyword selected by the user from the first keyword set.

Step 104: Acquire an information digest of network information corresponding to each keyword in the second keyword set, and send the information digest to the terminal.

In this embodiment of the present invention, a server sends a first keyword set consisting of several keywords having highest click-through rates to a terminal corresponding to a user, so that the user may select, in the first keyword set, a keyword in which the user is interested, so as to acquire an information digest page including multiple pieces of network information related to the selected keyword, and select, according to network information digests, network information that the user wants to acquire; this embodiment of the present invention provides more choices for the user, and meets user's requirement for a large amount of network information.

### Embodiment 2

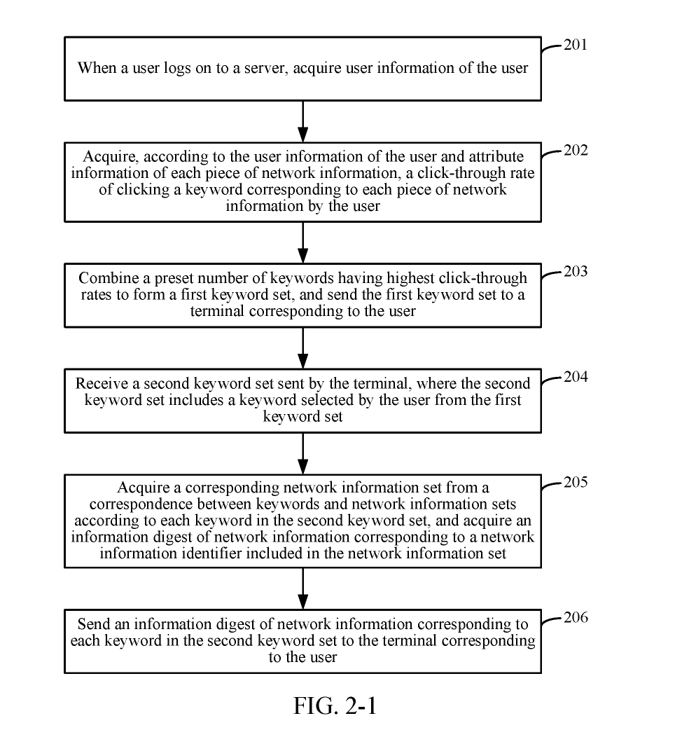

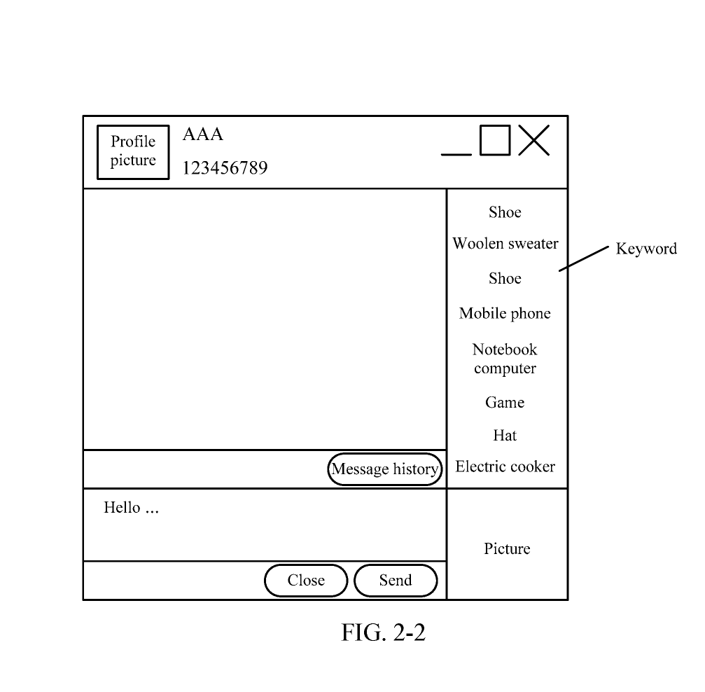

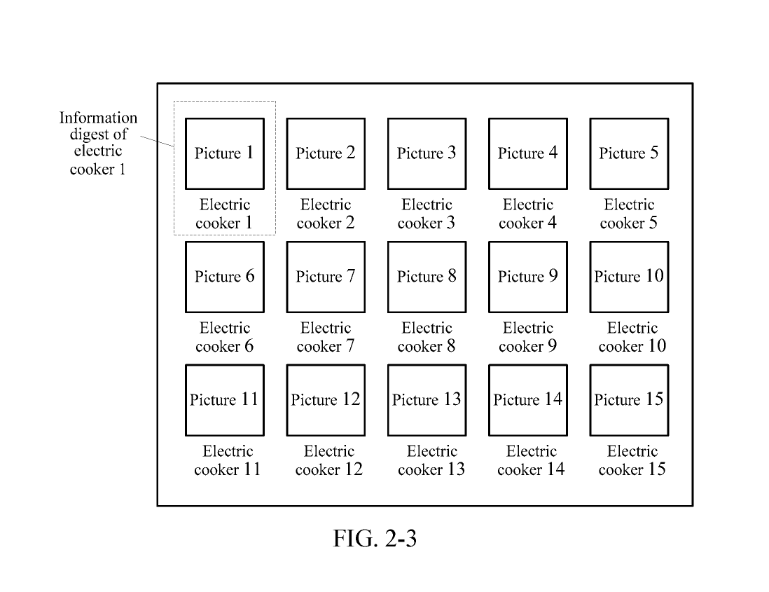

This embodiment of the present invention provides a method for acquiring an information digest. After a user logs onto a server, the method provided in this embodiment of the present invention helps the user acquire an information digest of network information. Referring to FIG. 2-1, the method may include:

Step 201: When a user logs onto a server, acquire user information of the user.

The user information of the user may be: the age, the gender, a geographical location, and interests and hobbies of the user, a behavior record of the user in a latest period of time having preset duration, and/or a keyword included in network information currently browsed by the user.

The age, the gender, and the interests and hobbies of the user may be acquired in the following manner, specifically: when the user registers an account in the server in advance, the server combines information such as the age, the gender, and the interests and hobbies that are registered by the user to form account information of the user, and stores a user identifier registered by the user and the account information in a correspondence between user identifiers and account information. Correspondingly, the server acquires the account information of the user from the correspondence between user identifiers and account information according to the user identifier of the user, and acquires the age, the gender, and the interests and hobbies of the user from the account information of the user.

The behavior record may be acquired in the following manner, specifically: the user account of the user further includes a historical record file, and the historical record file is used for storing network information browsed by the user and a browsing time. Correspondingly, the server acquires the historical record file of the user from the user account of the user, acquires, from the historical record file, the network information browsed in the latest period of time having the preset duration, acquires keywords corresponding to these pieces of network information, collects statistics about the acquired keywords to obtain the number of times each acquired keyword is browsed, and uses each acquired keyword and the number of times each keyword is browsed as the behavior record in the latest period of time having the preset duration.

For the geographical location of the user, a terminal corresponding to the user locates the user, to obtain the geographical location of the user, and sends the geographical location of the user to the server. The server receives the geographical location of the user.

The terminal may locate the user in the following three manners to obtain the geographical location of the user:

http://baike.baidu.com/view/68567.htm In the first manner, the terminal locates itself by using a Global Positioning System (GPS) built in the terminal, to obtain location coordinates of the terminal, and uses the location coordinates as the geographical location of the user,

where the location coordinates may be a longitude coordinate and a latitude coordinate.

In the second manner, the terminal acquires location coordinates of a base station accessed by the terminal, and uses the location coordinates as the geographical location of the user.

http://baike.baidu.com/view/1804790.htm In the third manner, the terminal acquires location coordinates of a wireless fidelity (WiFi) network accessed by the terminal, and uses the location coordinates as the geographical location of the user,

The server may be an instant messaging server; after the user logs onto the instant messaging server, the user may open an instant messaging chat interface; after the user opens the instant messaging chat interface, the server starts to acquire the user information of the user.

Step 202: Acquire, according to the user information of the user and attribute information of each piece of network information, a click-through rate of clicking a keyword corresponding to each piece of network information by the user.

Specifically, each record in the stored correspondence between keywords and network information sets includes a network information set and a keyword corresponding to the network information set, and a click-through rate of clicking network information corresponding to each network information identifier in the network information set by the user is calculated according to the user information of the user and attribute information of the network information corresponding to each network information identifier in the network information set; and the click-through rate of clicking the keyword corresponding to the network information set by the user is calculated according to the click-through rate of clicking the network information corresponding to each network information identifier in the network information set by the user.

Preferably, the click-through rate of clicking each piece of network information by the user is calculated according to the following step (A-1) to step (A-8), including:

(A-1): Acquire a gender eigenvalue of the network information according to the gender of the user and a user gender to which the network information is applicable.

Specifically, if the network information has a requirement on the user gender to which it is applicable, for example, when the network information is applicable to male users or female users, it is determined whether the gender of the user is the same as the user gender to which the network information is applicable; if the gender of the user is the same as the user gender to which the network information is applicable, the gender eigenvalue of the network information is set to a first value; if the gender of the user is not the same as the user gender to which the network information is applicable, the gender eigenvalue of the network information is set to a second value; if the network information has no requirement on the user gender to which it is applicable, for example, when the network information is applicable to male and female users, the gender eigenvalue of the network information is set to a third value.

For example, the first value may be 1, the second value may be 0, and the third value may be 0.5.

(A-2): Acquire a geographical location eigenvalue of the network information according to the geographical location of the user and an area to which the network information is applicable.

Specifically, if the geographical location of the user is in the area to which the network information is applicable, the geographical location eigenvalue of the network information is set to a fourth value.

If the geographical location of the user is not in the area to which the network information is applicable, the geographical location eigenvalue of the network information is set to a fifth value.

For example, the fourth value may be 1 and the fifth value may be 0.

(A-3): Acquire a time eigenvalue of the network information according to a current time and a time range to which the network information is applicable.

Specifically, if the current time is in the time range to which the network information is applicable, the time eigenvalue of the network information is set to a sixth value.

If the current time is not in the time range to which the network information is applicable, the time eigenvalue of the network information is set to a seventh value.

For example, the sixth value may be 1 and the seventh value may be 0.

(A-4): Acquire an age eigenvalue of the network information according to the age of the user and an age to which the network information is applicable.

Specifically, if the age to which the network information is applicable is a specific age and is the same as the age of the user, the age eigenvalue of the network information is set to an eighth value.

If the age to which the network information is applicable is a specific age and is different from the age of the user, the age eigenvalue of the network information is set to a ninth value.

If the age to which the network information is applicable is an age range and the age of the user is not within the range, the age eigenvalue of the network information is set to a tenth value.

If the age to which the network information is applicable is an age range and the age of the user is within the range, the age eigenvalue of the network information is set to an eleventh value.

For example, the eighth value may be 1, the ninth value may be 0, the tenth value may be 0, and the eleventh value may be 1.

(A-5): Acquire a first keyword eigenvalue of the network information according to a keyword of the interests and hobbies of the user and a keyword included in the network information.

Specifically, among the keywords of the network information, a keyword the same as and/or similar to the keyword of the interests and hobbies of the user is acquired, the number of the acquired keywords is counted, a ratio of the counted number to the number of keywords included in the interests and hobbies of the user is calculated, and the calculated ratio is used as the first keyword eigenvalue of the network information.

(A-6): Acquire a second keyword eigenvalue of the network information according to a behavior record of the user and the keyword included in the network information.

Specifically, in the behavior record of the user in the latest period of time having the preset duration, a keyword the same as and/or similar to the keyword of the network information is acquired, and the number of times each keyword is sent is acquired, and the acquired number of times is accumulated to obtain a first accumulated value; the number of times corresponding to each keyword included in browsing behaviors of the user in the latest period of time is acquired, the acquired number of times is accumulated to obtain a second accumulated value, a ratio of the first accumulated value to the second accumulated value is calculated, and the calculated ratio is used as the second keyword eigenvalue of the network information.

(A-7): Acquire a third keyword eigenvalue of the network information according to a keyword included in a page currently browsed by the user and the keyword included in the network information.

Specifically, among the keywords of the network information, a keyword the same as and/or similar to the keyword included in the page currently browsed by the user is acquired, the number of acquired keywords is counted, a ratio of the counted number to the number of the keywords included in the page currently browsed by the user is calculated, and the calculated ratio is used as the third keyword eigenvalue of the network information.

(A-8): Calculate the click-through rate G(x) of the network information according to the acquired age eigenvalue, gender eigenvalue, geographical location eigenvalue, time eigenvalue, first keyword eigenvalue, second keyword eigenvalue, and third keyword eigenvalue of the network information and based on the following formula (1);

G(x)=β0+β1X1+β2X2+γ3X3+β4X4+β5X5+β6X6+β7X7 (1);

where, in the foregoing formula (1), β0 is a preset first weight, β1 is a preset second weight, β2 is a preset third weight, β3 is a preset fourth weight, β4 is a preset fifth weight, β5 is a preset sixth weight, β6 is a preset seventh weight, and β7 is a preset eighth weight; values of β0, β1, β2, β3, β4, β5, β6, and β7 can all be set according to a specific case, and are not limited in the present disclosure; X1 is the geographical location eigenvalue, X2 is the age eigenvalue, X3 is the gender eigenvalue, X4 is the time eigenvalue, X5 is the first keyword eigenvalue, X6 is the second keyword eigenvalue, and the X7 is the third keyword eigenvalue.

Preferably, the calculating, according to the click-through rate of clicking the network information corresponding to each network information identifier in the network information set by the user, a click-through rate of clicking a keyword corresponding to the network information set by the user includes that:

the server separately multiplies the click-through rate of clicking the network information corresponding to each network information identifier by the user by a weight of the network information corresponding to each network information identifier, to obtain a product of the network information corresponding to each network information identifier; accumulates the product of the network information corresponding to each network information identifier, to obtain an accumulated value, calculates a ratio of the accumulated value to the number of the network information identifiers included in the network information set, and uses the calculated ratio as the click-through rate of clicking the keyword corresponding to the network information set by the user.

Step 203: Combine the preset number of keywords having highest click-through rates to form a first keyword set, and send the first keyword set to a terminal corresponding to the user.

The preset value may be 5, 8, or 10, and is not limited in the present disclosure.

The terminal receives the first keyword set and displays the first keyword set. For example, referring to FIG. 2-2, the keywords included in the first keyword set may be displayed in a preset area of the instant messaging chat interface.

When the user needs to acquire the information digest of the network information, the user may select one or more keywords and submit the keywords to the terminal. The terminal acquires the keywords selected by the user, combines the keywords selected by the user to form a second keyword set, and sends the second keyword set to the server.

Step 204: Receive a second keyword set sent by the terminal, where the second keyword set includes a keyword selected by the user from the first keyword set.

Further, the number of keywords included in the second keyword set is acquired, and is recorded as a first number.

Step 205: Acquire a corresponding network information set from a correspondence between keywords and network information sets according to each keyword in the second keyword set, and acquire an information digest of network information corresponding to a network information identifier included in the network information set.

Preferably, the acquiring an information digest of network information corresponding to a network information identifier included in the network information set may be:

filtering, according to the current time, the age, the gender, and/or the geographical location of the user that are included in the user information of the user, and the attribute information of the network information corresponding to each network information identifier included in the network information set, the network information identifiers included in the network information set, where network information applicable to a user gender that does not conform to the user gender, network information applicable to a user age range that does not include the age of the user, network information applicable to an area that does not include the geographical location of the user, and network information applicable to a time range that does not include the current time may be filtered out; and acquiring an information digest of network information corresponding to a network information identifier included in the network information set after the filtering.

For example, network information 1 acquired by the server from the network information set is applicable to a user age range of 20 years old to 25 years old, applicable to a user gender of male, applicable to an area of Nanjing, and applicable to a time range of 8:00 to 15:00; network information 2 is applicable to a user age range of 18 years old to 28 years old, applicable to a user gender of female, applicable to an area of Nanjing, and applicable to a time range of 11:00 to 24:00. The acquired age of the user is 24 years old, the gender is male, the location coordinates are (5,5), and the current time is 12:00. It is determined, according to the acquired location coordinates (5,5) of the user, that the user is located in Nanjing; the acquired user age, gender, and current time separately conform to the age, gender, and time range to which the network information 1 is applicable; therefore, the network information 1 is reserved. The acquired user gender does not conform to the user gender to which the network information 2 is applicable, and therefore, the network information 2 is filtered out.

Step 206: Send an information digest of network information corresponding to each keyword in the second keyword set to the terminal corresponding to the user.

Specifically, the server sorts the information digest of the network information corresponding to each keyword in the second keyword set according to the click-through rate of clicking the network information corresponding to each keyword in the second keyword set by the user; and creates a first number of blank web pages, separately adds the sorted information digest of the network information corresponding to each keyword to the created blank web pages, and sends, to the terminal corresponding to the user, the web pages added with the sorted information digests.

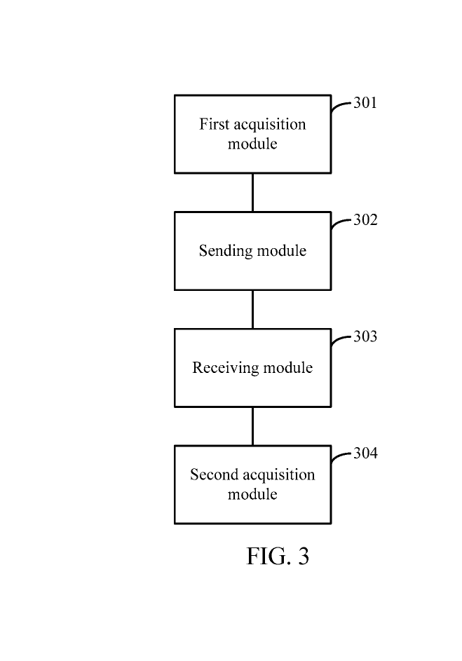

For example, a page added with information digests of network information corresponding to a keyword “electric cooker” is shown in FIG. 2-3.

The terminal displays the web page added with information digests, and the user clicks an information digest of a piece of network information in the displayed web page, so as to trigger the terminal to send an acquisition request message to the server, where the acquisition request message carries the identifier of the network information. The server receives the acquisition request message, acquires the identifier of the network information, acquires the network information according to the identifier of the network information, and sends the network information to the terminal corresponding to the user. The terminal corresponding to the user receives and displays the network information.

In this embodiment of the present invention, a server sends a first keyword set consisting of several keywords having highest click-through rates to a terminal corresponding to a user, so that the user may select, in the first keyword set, a keyword in which the user is interested, so as to acquire an information digest page including multiple pieces of network information related to the selected keyword, and select, according to network information digests, network information that the user wants to acquire; this embodiment of the present invention provides more choices for the user, and meets user's requirement for a large amount of network information.

### Embodiment 3

Referring to FIG. 3, this embodiment of the present invention provides an apparatus for acquiring an information digest, including:

a first acquisition module 301, configured to acquire, according to user information of a user and attribute information of each piece of network information, a click-through rate of clicking a keyword corresponding to each piece of network information by the user;

a sending module 302, configured to combine a preset number of keywords having highest click-through rates to form a first keyword set, and send the first keyword set to a terminal corresponding to the user;

a receiving module 303, configured to receive a second keyword set sent by the terminal, where the second keyword set includes a keyword selected by the user from the first keyword set; and

a second acquisition module 304, configured to acquire an information digest of network information corresponding to each keyword in the second keyword set, and send the information digest to the terminal.

Preferably, the first acquisition module 301 includes:

a first acquisition unit, configured to acquire, from a correspondence between keywords and network information sets, a network information set and a keyword corresponding to the network information set;

a first calculation unit, configured to calculate, according to the user information of the user and attribute information of network information corresponding to each network information identifier in the network information set, a click-through rate of clicking the network information corresponding to each network information identifier by the user; and

a second calculation unit, configured to calculate, according to the click-through rate of clicking the network information corresponding to each network information identifier by the user, a click-through rate of clicking the keyword by the user.

Preferably, the second calculation unit includes:

an operation subunit, configured to separately multiply the click-through rate of clicking the network information corresponding to each network information identifier by the user by a weight of the network information corresponding to each network information identifier, to obtain a product of the network information corresponding to each network information identifier; and

an accumulation subunit, configured to accumulate the product of the network information corresponding to each network information identifier to obtain an accumulated value, calculate a ratio of the accumulated value to the number of the network information identifiers included in the network information set, and use the ratio as the click-through rate of clicking the keyword by the user.

Further, the apparatus further includes:

a categorization module, configured to categorize each piece of network information according to a keyword, categorize identifiers of network information corresponding to a same keyword into one network information set, and store the keyword and the network information set in the correspondence between keywords and network information sets.

Preferably, the second acquisition module 304 includes:

a sorting unit, configured to sort, according to a click-through rate of clicking the network information corresponding to each keyword in the second keyword set by the user, the information digest of the network information corresponding to each keyword in the second keyword set; and

a creating unit, configured to create a blank web page, add the sorted information digest of the network information to the web page, and send the web page to the terminal corresponding to the user.

Further, the apparatus further includes:

a third acquisition module, configured to acquire a corresponding network information set from a correspondence between keywords and network information sets according to each keyword in the second keyword set; and

a fourth acquisition module, configured to acquire an information digest of network information corresponding to a network information identifier included in the network information set.

Preferably, the fourth acquisition module includes:

a filtering unit, configured to filter, according to a current time, the age, the gender, and/or a geographical location of the user that are included in the user information of the user, and the attribute information of the network information corresponding to each network information identifier included in the network information set, the network information identifiers included in the network information set; and

a second acquisition unit, configured to acquire an information digest of network information corresponding to a network information identifier included in the network information set after the filtering.

In this embodiment of the present invention, a server sends a first keyword set consisting of several keywords having highest click-through rates to a terminal corresponding to a user, so that the user may select, in the first keyword set, a keyword in which the user is interested, so as to acquire an information digest page including multiple pieces of network information related to the selected keyword, and select, according to network information digests, network information that the user wants to acquire; this embodiment of the present invention provides more choices for the user, and meets user's requirement for a large amount of network information.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for acquiring an information digest, comprising:
acquiring, according to user information of a user and attribute information of each piece of network information, a click-through rate of clicking a keyword corresponding to each piece of network information by the user;
combining a preset number of keywords having highest click-through rates to form a first keyword set, and sending the first keyword set to a terminal corresponding to the user;
receiving a second keyword set sent by the terminal, the second keyword set comprising a keyword selected by the user from the first keyword set; and
acquiring an information digest of network information corresponding to each keyword in the second keyword set, and sending the information digest to the terminal.

2. The method according to claim 1, wherein the acquiring, according to user information of a user and attribute information of each piece of network information, a click-through rate of clicking a keyword corresponding to each piece of network information by the user comprises:
acquiring, from a correspondence between keywords and network information sets, a network information set and a keyword corresponding to the network information set;
calculating, according to the user information of the user and attribute information of network information corresponding to each network information identifier in the network information set, a click-through rate of clicking the network information corresponding to each network information identifier by the user; and
calculating, according to the click-through rate of clicking the network information corresponding to each network information identifier by the user, a click-through rate of clicking the keyword by the user.

3. The method according to claim 2, wherein the calculating, according to the click-through rate of clicking the network information corresponding to each network information identifier by the user, a click-through rate of clicking the keyword by the user comprises:
separately multiplying the click-through rate of clicking the network information corresponding to each network information identifier by the user by a weight of the network information corresponding to each network information identifier, to obtain a product of the network information corresponding to each network information identifier; and
accumulating the product of the network information corresponding to each network information identifier to obtain an accumulated value, calculating a ratio of the accumulated value to the number of the network information identifiers comprised in the network information set, and using the ratio as the click-through rate of clicking the keyword by the user.

4. The method according to claim 2, before the acquiring a click-through rate of clicking a keyword corresponding to each piece of network information by the user, further comprising:
categorizing each piece of network information according to a keyword, categorizing identifiers of network information corresponding to a same keyword into one network information set, and storing the keyword and the network information set in the correspondence between keywords and network information sets.

5. The method according to claim 1, wherein the acquiring an information digest of network information corresponding to each keyword in the second keyword set, and sending the information digest to the terminal comprises:
sorting, according to a click-through rate of clicking the network information corresponding to each keyword in the second keyword set by the user, the information digest of the network information corresponding to each keyword in the second keyword set; and
creating a blank web page, adding the sorted information digest of the network information to the web page, and sending the web page to the terminal corresponding to the user.

6. The method according to claim 1, before the acquiring an information digest of network information corresponding to each keyword in the second keyword set, and sending the information digest to the terminal, further comprising:
acquiring a corresponding network information set from a correspondence between keywords and network information sets according to each keyword in the second keyword set; and
acquiring an information digest of network information corresponding to a network information identifier comprised in the network information set.

7. The method according to claim 6, wherein the acquiring an information digest of network information corresponding to a network information identifier comprised in the network information set comprises:
filtering, according to a current time, the age, the gender, and/or a geographical location of the user that are comprised in the user information of the user, and attribute information of the network information corresponding to each network information identifier comprised in the network information set, the network information identifiers comprised in the network information set; and
acquiring an information digest of network information corresponding to a network information identifier comprised in the network information set after the filtering.

8. An apparatus for acquiring an information digest, comprising:
a first acquisition module, configured to acquire, according to user information of a user and attribute information of each piece of network information, a click-through rate of clicking a keyword corresponding to each piece of network information by the user;
a sending module, configured to combine a preset number of keywords having highest click-through rates to form a first keyword set, and send the first keyword set to a terminal corresponding to the user;
a receiving module, configured to receive a second keyword set sent by the terminal, the second keyword set comprising a keyword selected by the user from the first keyword set; and
a second acquisition module, configured to acquire an information digest of network information corresponding to each keyword in the second keyword set, and send the information digest to the terminal.

9. The apparatus according to claim 8, wherein the first acquisition module comprises:
a first acquisition unit, configured to acquire, from a correspondence between keywords and network information sets, a network information set and a keyword corresponding to the network information set;
a first calculation unit, configured to calculate, according to the user information of the user and attribute information of network information corresponding to each network information identifier in the network information set, a click-through rate of clicking the network information corresponding to each network information identifier by the user; and
a second calculation unit, configured to calculate, according to the click-through rate of clicking the network information corresponding to each network information identifier by the user, a click-through rate of clicking the keyword by the user.

10. The apparatus according to claim 9, wherein the second calculation unit comprises:
an operation subunit, configured to separately multiply the click-through rate of clicking the network information corresponding to each network information identifier by the user by a weight of the network information corresponding to each network information identifier, to obtain a product of the network information corresponding to each network information identifier; and
an accumulation subunit, configured to accumulate the product of the network information corresponding to each network information identifier to obtain an accumulated value, calculate a ratio of the accumulated value to the number of the network information identifiers comprised in the network information set, and use the ratio as the click-through rate of clicking the keyword by the user.

11. The apparatus according to claim 9, wherein the apparatus further comprises:
a categorization module, configured to categorize each piece of network information according to a keyword, categorize identifiers of network information corresponding to a same keyword into one network information set, and store the keyword and the network information set in the correspondence between keywords and network information sets.

12. The apparatus according to claim 8, wherein the second acquisition module comprises:
a sorting unit, configured to sort, according to a click-through rate of clicking the network information corresponding to each keyword in the second keyword set by the user, the information digest of the network information corresponding to each keyword in the second keyword set; and
a creating unit, configured to create a blank web page, add the sorted information digest of the network information to the web page, and send the web page to the terminal corresponding to the user.

13. The apparatus according to claim 8, wherein the apparatus further comprises:
a third acquisition module, configured to acquire a corresponding network information set from a correspondence between keywords and network information sets according to each keyword in the second keyword set; and
a fourth acquisition module, configured to acquire an information digest of network information corresponding to a network information identifier comprised in the network information set.

14. The apparatus according to claim 13, wherein the fourth acquisition module comprises:
a filtering unit, configured to filter, according to a current time, the age, the gender, and/or a geographical location of the user that are comprised in the user information of the user, and attribute information of the network information corresponding to each network information identifier comprised in the network information set, the network information identifiers comprised in the network information set; and
a second acquisition unit, configured to acquire an information digest of network information corresponding to a network information identifier comprised in the network information set after the filtering.

15. The method according to claim 3, before the acquiring a click-through rate of clicking a keyword corresponding to each piece of network information by the user, further comprising:
categorizing each piece of network information according to a keyword, categorizing identifiers of network information corresponding to a same keyword into one network information set, and storing the keyword and the network information set in the correspondence between keywords and network information sets.

16. The apparatus according to claim 10, wherein the apparatus further comprises:
a categorization module, configured to categorize each piece of network information according to a keyword, categorize identifiers of network information corresponding to a same keyword into one network information set, and store the keyword and the network information set in the correspondence between keywords and network information sets.
